(19) United States
(12) Patent Application Publication
(10) Pub. No.: US 2009/0199079 A1
(43) Pub. Date: Aug. 6, 2009

(54) EMBEDDED CUES TO FACILITATE APPLICATION DEVELOPMENT

(75) Inventor: Christopher H. Pratley, Seattle, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/023,802

(22) Filed: Jan. 31, 2008

(51) Int. Cl. G06F 17/00; G06F 3/048; G06F 3/00

(52) U.S. Cl. 715/205; 715/805; 715/708

(57) ABSTRACT

A system is provided to facilitate documentation processing. The system includes one or more embedded components associated with an application and a linking component to automatically associate the embedded components with one or more related entities to the document. The embedded components are employed to determine other relationships for the document.

### BACKGROUND

Traditionally, communications between humans and machines have been relatively inefficient. Human-to-human communication typically involves spoken language combined with hand and facial gestures or expressions, with the humans understanding the context of the communication. Human-machine communication is typically much more constrained, with devices like keyboards and mice for input, and symbolic or iconic images on a display for output, and with the machine understanding very little of the context. For example, although communication mechanisms (e.g., speech recognition systems) continue to develop, these systems do not automatically adapt to the activity of a user. As well, traditional systems do not consider contextual factors (e.g., user state, application state, environment conditions) to improve communications and interactivity between humans and machines.

Present human interface systems come in many forms and provide one type of interactivity. There is the common graphical user interface used on desk top computers and various other forms such as button controls and menus commonly employed by mobile devices such as cell phones. Most interface systems operate in a somewhat static environment and generally provide static choices as to how humans may interact with the respective systems. For example, when operating a cell phone, a static menu list is provided to the user that allows adjusting the various features of the phone such as sounds, numbers, functionality, and so forth. In a desk top situation, depending on the application that is selected, a standard set of interfaces and static grouping of interface options are provided. These interfaces often don't account for the particular nuances of a user nor do they provide any type of context for other users who may employ the interface and associated application program.

Often times, interfaces drive applications such as for the generation of a text or document. Such interfaces facilitate handling and processing of the document in an efficient manner but as noted above provide a core set of static options for opening and editing the respective document. When reading a document, often times the context that went into the overall document creation is missing. Such context is often related to those who have collaborated in the generation of the document. Current systems and interfaces do not provide for determining such context.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Links or related tags are automatically determined for a given application, where the links are employed to determine relevant contexts for the application to facilitate further collaboration among users or systems. Such links can be automatically embedded as contextual cues and employed by users to determine who else is working on an application, who has worked on it in the past, the current wave of thinking for a given subject matter, what is happing at this moment or right now, who are likely collaborators, and so forth. Such links can be inferred from profiles and from metadata queries of e-mails, documents, applications, and so forth. By determining other related entities, workers who work alone can collaborate with a larger and sometimes unknown group and thus leveraging ideas from the group.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a system for determining and processing embedded cues in an application.

FIG. 2 is a block diagram that illustrates a data generation and analysis system.

FIG. 3 illustrates example data forms that can be employed for embedded cues.

FIG. 4 illustrates example system employing a linking component, where the system can automatically determine and embed data as contextual cues for other users to view in an application.

FIG. 5 illustrates an example user profile that can be employed to control how documents are updated and how links are processed.

FIG. 6 illustrates an exemplary activity monitoring system that facilitates determining links and other cues that may be relevant for a given application.

FIG. 7 illustrates a system for application tagging and embedding links using automatically determined contextual data.

FIG. 8 illustrates an exemplary process for automatically determining and embedding context links or cues in accordance with one or more applications.

FIG. 9 is a schematic block diagram illustrating a suitable operating environment.

FIG. 10 is a schematic block diagram of a sample-computing environment.

### DETAILED DESCRIPTION

Systems and methods are provided for adding context to documents in order to facilitate collaboration with other users of the document or file. In one aspect, a system is provided to facilitate documentation processing. The system includes one or more embedded components associated with an application and a linking component to automatically associate the embedded components with one or more related entities to the document. The embedded components are employed to determine other relationships for the document such as who collaborated to generate the document and what were the relevant contexts when the document was created.

As used in this application, the terms “component,” “application,” “link,” “database,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

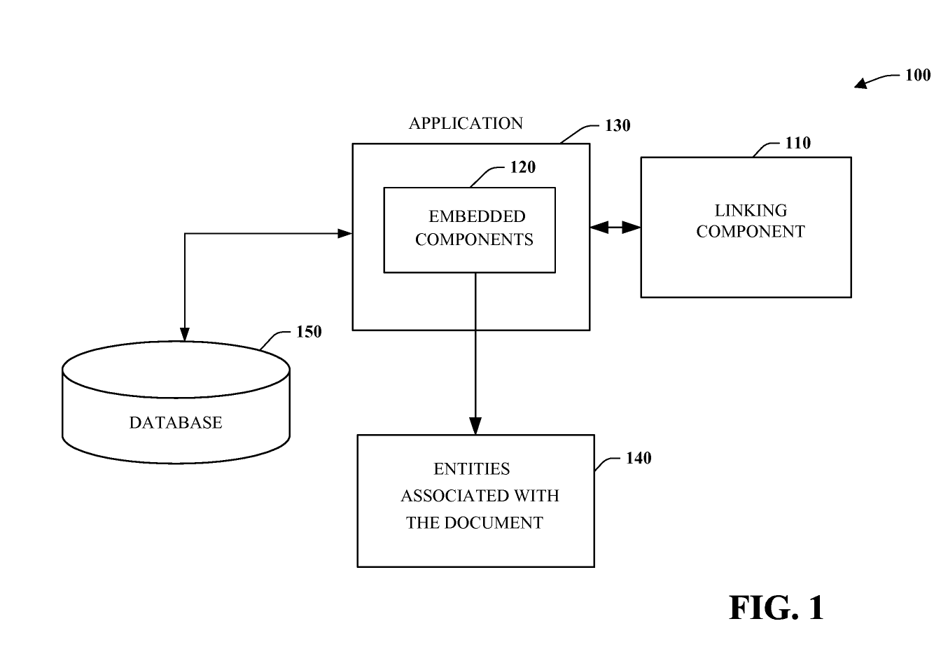

Referring initially to FIG. 1, a system 100 is illustrated for determining and processing embedded cues in an application. The system 100 includes a linking component 110 that determines one or more embedded components 120 for an application 130. The application 130 can be associated with substantially any type of file such as a document, a presentation file, a source code file, an application development file, a project file and so forth. As shown, one or more entities 140 associated with the application 130 can use the embedded components 120 to determine relevant information or context for the application. For example, several developers may have collaborated on a source code file where the embedded components 120 provide comments or other discussion related to the file. Such comments or discussion can be automatically recorded from meetings or derived from other collaborations such as e-mails or conference calls. If an individual were to work on a document separate from the group, notes or other commentary can be automatically determined and embedded in the document. This data can be incorporated as metadata or provided via user interface elements as described in more detail below. A database 150 can be provided to aggregate context data overtime that can later be employed by the linking component 110 to create one or more of the embedded components 120.

In general, applications 130 are monitored for user activity. Activities can include e-mails, meeting notes, audio files where an application is discussed, video data, presentation data, and substantially any type of data that is associated with a given application. In a developer application, this could include all the meetings and discussions relating to source code in addition to follow-up e-mails related to the code, for example. Links or related tags are automatically determined for a given application, where the links or embedded cues/components are employed to determine relevant contexts for the application 130 to facilitate further collaboration among users or systems. Links can be embedded as metadata or embedded under a user interface tab for example, to show users of the application 130 that there is further contextual data (e.g., notes, conversations, e-mails, comments, and so forth) that was generated for the application. The links that were associated with the application 130 can now be employed by one or more users of the respective application at 140 to determine what other users of the document were thinking or have contributed to the document. For example, the links can be employed to determine who else is working on the application, who has worked on it in the past, the current wave of thinking for the application, what is happing at this moment or right now, who are likely collaborators, and so forth. Such links or embedded components 120 can be inferred from profiles and from metadata queries of e-mails, documents, applications, and so forth as will be described in more detail below.

By determining other related entities, workers who work alone can collaborate with a larger and sometimes unknown group and leveraging ideas from the group via the associated links or cues which are embedded at 120. In another aspect, a data context system is provided. This includes means for determining a context from a group (linking component 110) and means for receiving a data packet from the determined context (application 130). This also includes means for associating the data packet (embedded component 120) to provide the context to other systems or users.

Data for the system 100 can be gleaned and analyzed from a single source or across multiple data sources, where such sources can be local or remote data stores or databases 150. This can include files or data structures that maintain states about the user and can be employed to determine future states. These can be past action files for instance that store what a user has done in the past and can be used by intelligent components such as classifiers to predict future actions. Related aspects can be annotating or processing metadata that could be attached to e-mails or memoranda for example. Data can be employed to facilitate interpersonal sharing, trusted modes, and context sharing for example. Data which can be stored at 150 can also be employed to control virtual media presentations and control community interactions such as the type of interface or avatar that may be displayed for a respective user on a given day. Interactive data can be generated in view of the other data.

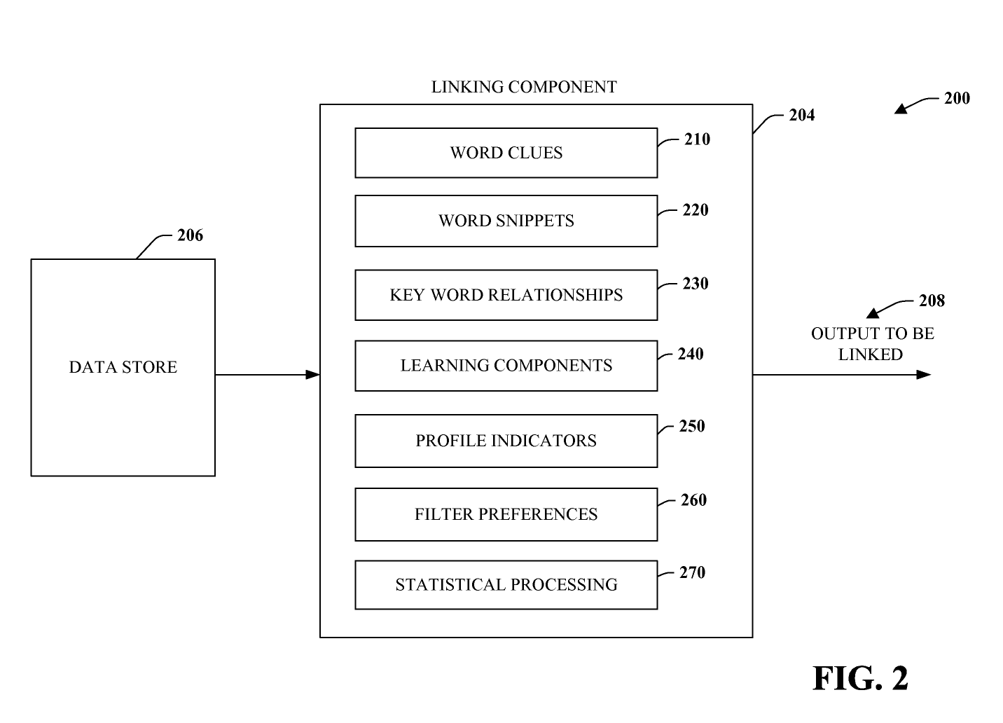

Referring now to FIG. 2, a data generation and analysis system 200 is illustrated. The system 200 includes a linking component 204 that analyzes a data store 206 and automatically produces output 208 that can be linked embedded with an application. The linking component 204 shows example factors that may be employed to analyze a given user environment to produce the output 208.

Proceeding to 210, one aspect for analyzing data from the data store 206 (also can be real time analysis such as received from a wireless transmission source) includes word or file clues 210. Such clues 210 may be embedded in a document or file and give some indication or hint as to the type of data being analyzed. For example, some headers in file may include words such as summary, abstract, introduction, conclusion, and so forth that may indicate the generator of the file has previously operated on the given text. These clues 210 may be used by themselves or in addition to other analysis techniques for generating the output 208. For example, merely finding a word summary wouldn't preclude further analysis and generation of output 208 based on other parts of the analyzed data from 206. In other cases, users can control analysis by stipulating that if such words are found in a document that the respective words should be given more weight for the summarized output 208 which may limit more complicated analysis described below.

At 220, one or more word snippets may be analyzed. This can include processes such as analyzing particular portions of a document to be employed for generation of the output 208. For example, analyze the first 20 words of each paragraph, or analyze the specified number of words at the beginning, middle and end of each paragraph for later use in automatic embedding of contextual data. Substantially any type of algorithm that searches a document for clusters of words that are a reduced subset of the larger corpus can be employed. Snippets 220 can be gathered from substantially any location in the document and may be restrained by user preferences or filter controls.

At 230, the linking component 204 may employ key word relationships to determine output 208. Key words may have been employed during an initial search of a data store or specified specifically to the linking component 204 via a user interface (not shown). Key words 230 can help the linking component 204 to focus its automated analysis near or within proximity to the words so specified. This can include gathering words throughout a document that are within a sentence or two of a specified keyword 230, only analyzing paragraphs containing the keywords, numerical analysis such as frequency the key word appears in a paragraph. Again, controls can modify how much weight is given to the key words 230 during a given analysis.

At 240, one or more learning components 240 can be employed by the linking component 204 to generate output 208. This can include substantially any type of learning process that monitors activities over time to determine how to embed data in subsequent applications. For example, a user could be monitored for such aspects as where in a document they analyze first, where their eyes tend to gaze, how much time the spend reading near key words and so forth, where the learning components 240 are trained over time to summarize in a similar nature as the respective user. Also, learning components 240 can be trained from independent sources such as from administrators who generate information, where the learning components are trained to automatically generate data based on past actions of the administrators. The learning components can also be fed with predetermined data such as controls that weight such aspects as key words or word clues that may influence the linking component 204. Learning components 240 can include substantially any type of artificial intelligence component including neural networks, Bayesian components, Hidden Markov Models, Classifiers such as Support Vector Machines and so forth.

At 250, profile indicators can influence how summaries are generated at 208. For example, controls can be specified in a user profile described below that guides the summarizer in its decision regarding what should and should not be included in the output 208. In a specific example, a business user may not desire to have more complicated mathematical expressions contained in output 208 where an Engineer may find that type of data highly useful in any type of output. Thus, depending on how preferences 250 are set in the user profile, the linking component 204 can include or exclude certain types of data at 208 in view of such preferences.

Proceeding to 260, one or more filter preferences may be specified that control output generation at 208. Similar to user profile indicators 250, filter preferences 260 facilitate control of what should or should not be included in the output 208. For example, rules or policies can be setup where certain words or phrases or data types are to be excluded from the output 208. In another example, filter preferences 260 may be used to control how the linking component 204 analyzes files from the data store in the first place. For instance, if a rule were setup that no mathematical expression were to be included in the output 208, the linking component 204 may analyze a given paragraph, determine that it contains mostly mathematical expressions and skip over that particular paragraph from further usage in the output 208. Substantially any type of rule or policy that is defined at 260 to limit or restrict output 208 or to control how the linking component 204 processes a given data set can be employed.

At 270, substantially any type of statistical process can be employed to generate output 208 for an application. This can include monitoring certain types of words such as key words for example for their frequency in a document or paragraph, for word nearness or distance to other words in a paragraph (or other media), or substantially any type of statistical processes that is employed to generate a subset of output from a larger corpus of data and included with the data store 206.

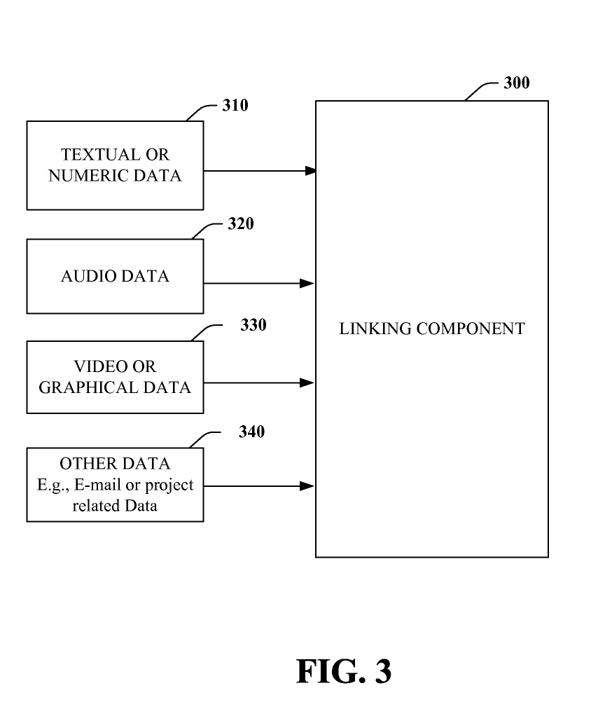

Turning to FIG. 3, a linking component 300 is illustrated where various forms of media can be employed as input and used to generate output 304 that can be embedded in an application. In this aspect, data can be analyzed in various forms, linked at 300, where the output 304 can include one or more of the various forms. As previously described, textual or numeric data can be analyzed at 310. This can include substantially any type of textual or mathematical data and can be in the form of substantially any type of spoken language, computer language, or such languages as scientific expressions for example.

At 320, audio data can be analyzed and employed to generate output 304. Such data can be analyzed in real time or from an audio file such as a wav file for example or other format. Natural language processors (not shown) can be employed or media can be changed in one form, analyzed to determine output 304, and stored in a form in the given media type. For example, an audio file 320 could be converted to text, analyzed by the linking 300 to determine which portion of the audio file should be included as part of the data, and then storing that portion as audio even though the analysis was performed in text.

At 330, video or graphical data can be analyzed an employed as part of the output 304. Similar to audio data 320, graphical files or real time video streams can be analyzed. In one example, clips of audio 320 or video 330 can be captured and used for the output data 304. This can include analyzing a scene or a sound for repetitious portions and using at least one of the portions for the clip or removing portions that are determined to be repetitious. This can include cropping pictures or video to capture the gist of a meeting yet reducing the overall amount of data that a user may need to process at 304. As shown, other data formats 340 that may not have been described herein can also be produced at 300 (generate a reduced dataset there from) and employed to generate output 304. For example, data 340 could be derived from one or more e-mails or other project discussions for a given development project. It is noted that the output 304 can include one or more forms of the data processed at 310 through 340. For example, output 304 can include textual summaries, mathematical summaries, audio summaries, photographic summaries, video summaries, notes, or substantially any data relating to a project, application, or document.

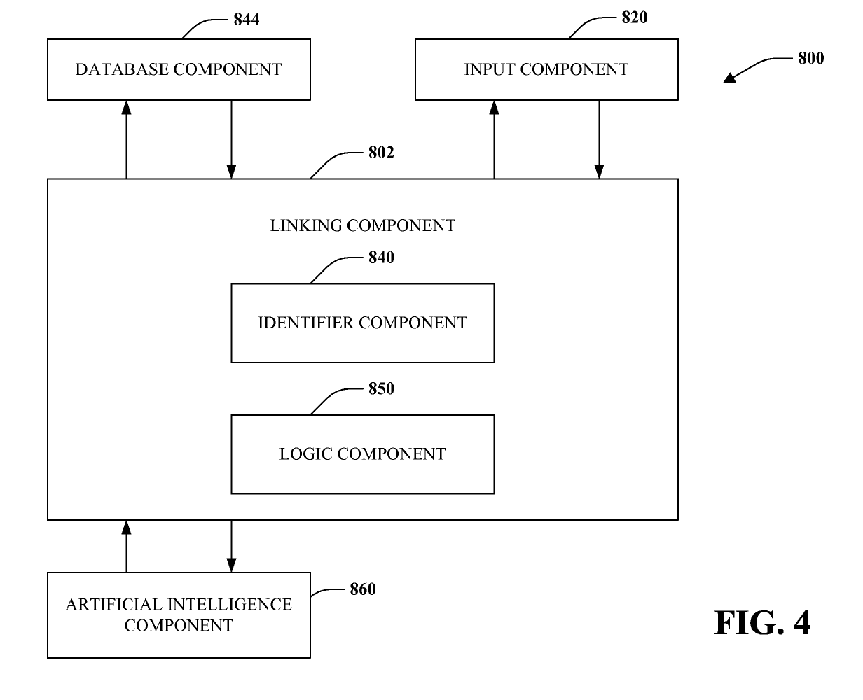

Referring to FIG. 4, a detailed system 400 employing a linking component 402 is illustrated, where the system can automatically determine and embed data as contextual cues for other users to view in an application. The linking component 402 receives a set of parameters from an input component 420. The parameters may be derived or decomposed from a specification provided by the user and parameters can be inferred, suggested, or determined based on logic or artificial intelligence. An identifier component 440 identifies suitable control steps, or methodologies to accomplish the linking of a particular item in accordance with the parameters of the specification. It should be appreciated that this may be performed by accessing a database component 444, which stores one or more component and methodology models. The linking component 402 can also employ a logic component 450 to determine which data component or model to use when augmenting an application or document.

When the identifier component 440 has identified the components or methodologies and defined models for the respective components or steps, the linking component 402 constructs, executes, and embeds data based upon an analysis or monitoring of a given application. In accordance with this aspect, the AI component 460 automatically generates various cues or links by monitoring present user activity. The AI component 460 can include an inference component (not shown) that further enhances automated aspects of the AI components utilizing, in part, inference based schemes to facilitate inferring data from which to augment an application. The AI-based aspects can be effected via any suitable machine learning based technique or statistical-based techniques or probabilistic-based techniques or fuzzy logic techniques. Specifically, the AI component 460 can implement learning models based upon AI processes (e.g., confidence, inference). For example, a model can be generated via an automatic classifier system.

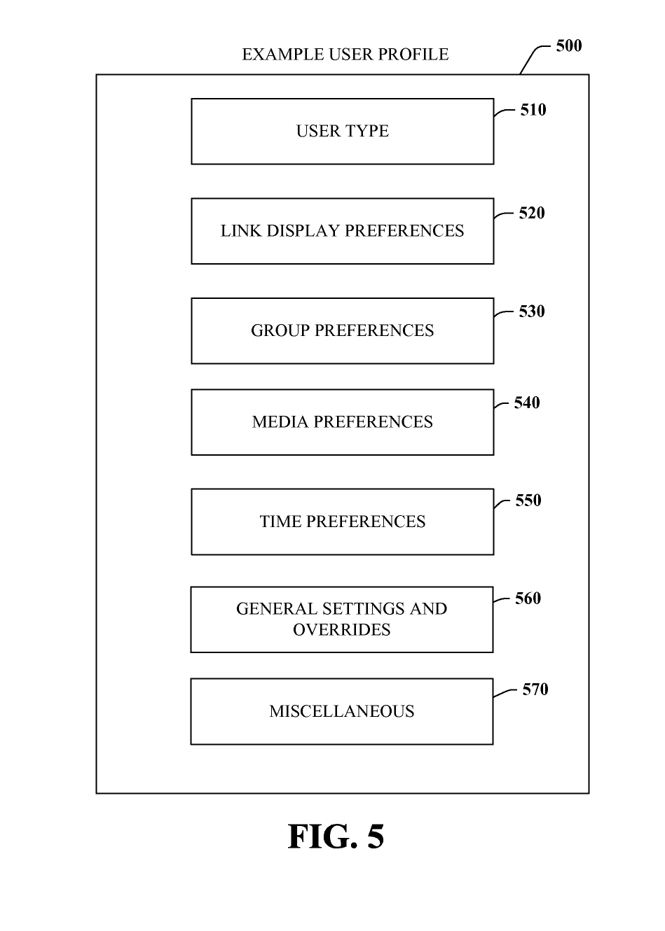

Proceeding to FIG. 5, an example user profile 500 is illustrated that can be employed to control how documents are updated and how links are processed. In general, the profile 500 allows users to control the types and amount of information that may be captured. Some users may prefer to receive more information associated with a given data store whereas others may desire information generated under more controlled or narrow circumstances. The profile 500 allows users to select and/or define options or preferences for generating application data. At 510, user type preferences can be defined or selected. This can include defining a class for a particular user such as adult, child, student, professor, teacher, novice, and so forth that can help control how much and the type of data that is created for a respective application. For example, a larger or more detailed link can be generated for a novice user over an experienced one.

Proceeding to 520, the user may indicate one or more link display preferences. For instance, the user may select how links are to be displayed such as via hovering over portions of a document or captured as part of a user interface where the embedded links a selected from a menu for example. At 530, group preferences may be defined. This can include defining members of a user's that can be employed to control how documents are updated and how links are processed s environment from which to share and/or receive linked information. Other aspects could include specifying media preferences at 540, where users can specify the types of media that can be included and/or excluded form a respective link. For example, a user may indicate that data is to include text and thumbnail images only but no audio or video clips are to be provided.

Proceeding to 550, time preferences can be entered. This can include absolute time information such as only provide perform data generation activities on weekends or other time indication. This can also include calendar information and other data that can be associated with time or dates in some manner. Proceeding to 570, general settings and overrides can be provided. These settings at 560 allow users to override what they generally use to control embedded information. For example, during normal work weeks, users may screen out want detailed data for all files generated for the week yet the override specifies that the summaries are only to be generated on weekends. When working on weekends, the user may want to simply disable one or more of the controls via the general settings and overrides 560. At 570, miscellaneous controls can be provided. These can include if then constructs or alternative languages for more precisely controlling how algorithms are processed and controlling respective data output formats.

The user profile 500 and controls described above can be updated in several instances and likely via a user interface that is served from a remote server or on a respective mobile device if desired. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating the profile 500 including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations, speech or facial recognition technologies can be employed to control when or how data is presented to the user. The profile 500 can be updated and stored in substantially any format although formats such as XML may be employed to store summary information.

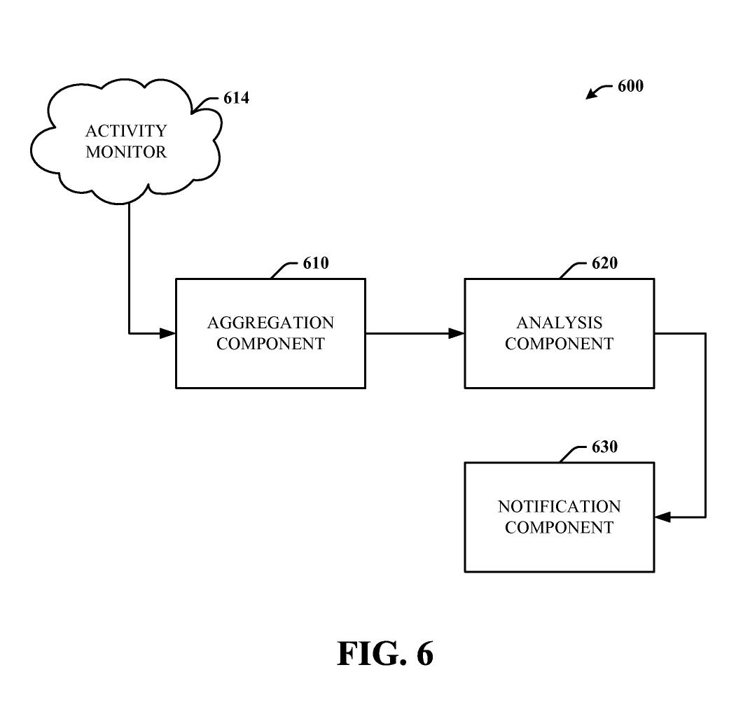

Referring to FIG. 6, an exemplary activity monitoring system 600 is illustrated that facilitates determining links and other cues that may be relevant for a given application. The system 600 includes an aggregation component 610 that aggregates activity data from a monitor component 614 and corresponding user data from local and/or remote users. The monitoring component 614 can monitor and collect activity data from one or more users on a continuous basis, when prompted, or when certain activities are detected (e.g., a particular application or document is opened or modified). Activity data can include but is not limited to the following: the application name or type, document name or type, activity template name or type, start/end date, completion date, category, priority level for document or matter, document owner, stage or phase of document or matter, time spent (e.g., total or per stage), time remaining until completion, and/or error occurrence. User data about the user who is engaged in such activity can be collected as well. This can include the user's name, title or level, certifications, group memberships, department memberships, experience with current activity or activities related thereto.

An analysis component 620 can process aggregated data 610 and then group it according to which users appear to be working on the same project or are working on similar tasks. In a work-related setting, this information can be displayed on a user interface for a group manager, for example, to readily view. Thus, the group manager can view the progress and/or performance data of the people he is managing. Even more so, this information can be accessed locally or remotely by group members (e.g., via web link). As a result, groups or related users can view each other's links or cues from any location. When some group members are located in different cities, states, or countries and across time zones, the ability to view each other's activity data and progress can enhance activity coordination and overall work experience.

The system 600 also includes a notification component 630. The notification component 630 can notify users that they can proceed with their activities based on the completion of prior steps (performed by other users). Likewise, when a user requests feedback on their activity, a notification can be sent to let him know when the feedback has been provided or if it is past due. This can help the user decide the most appropriate next step to take. Such notifications can be passed as document or other types of cues and can be tied to e-mails or other communications to allow members to know that an application has recently been updated with link.

Individual users (not associated with a group) can benefit from embedded information as well. In particular, they can gauge their progress or skill level by comparing their progress with other users who are working on or who have worked on the same or similar activity. They can also learn about the activity by viewing other users' comments or current state with regard to the activity. In addition, they can estimate how much more time is required to complete the activity based on the others' completion times which can be helpful for planning or scheduling purposes. All such activity data can be associated with an application for later or real time viewing by users.

The system 600 can also improve the distribution of similar or related activities by aggregating similar activities or tasks and assigning them to one or more selected users who could be specifically trained or knowledgeable in the particular activity. For example, suppose a user works for an investment firm and is highly trained in math, statistics, and finance and is a Certified Public Accountant. Many of the projects the firm is asked to handle have subparts dealing with accounting and statistical calculations. Because the user is so skilled in this area, he has become substantially efficient in completing such tasks but is far less efficient in other areas. Thus, the system 600 can aggregate similar tasks involving accounting and statistical calculations and then assign them to the user. New or unfinished tasks can be assigned or re-assigned to the user since in this case, reassigning them to the user is arguably more efficient and less costly to the system (and firm) than to have user merely provide assistance to other users in the middle of such tasks. Such aggregations of data can then be associated with an application and shared with others as is described in more detail below.

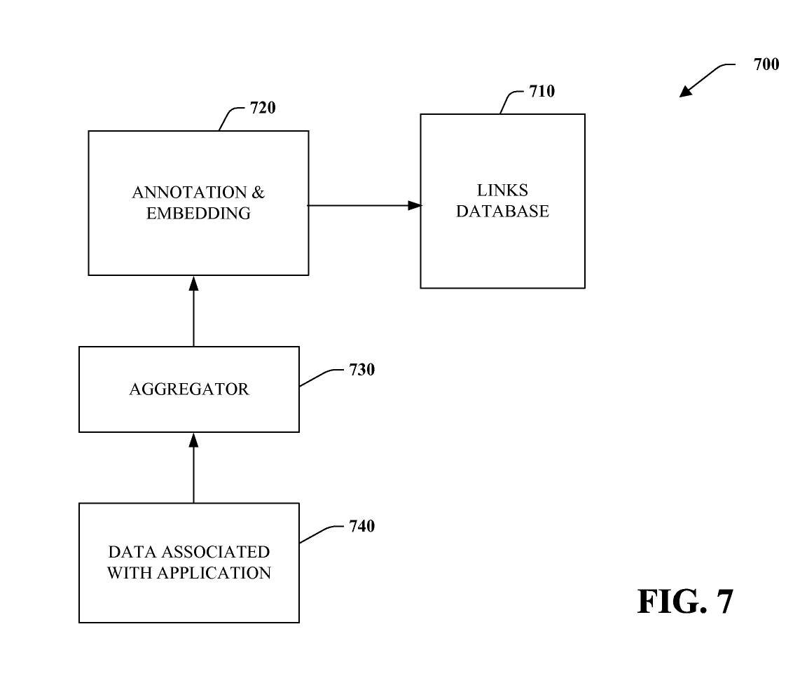

Referring now to FIG. 7, a system 700 illustrates application tagging and embedding links using automatically determined contextual data. In this aspect, determined contextual data can be employed as part of tagging systems that tag or annotate a given application. As shown, a links database 710 which can be a local data store or remote database receives data from an annotation & embedding component 720. The annotation component 720 is driven from an aggregator component 730. Contextual data is associated with an application at 740 and collected via the aggregator 730 to form an annotation or link at 720 which is subsequently stored at the links database 710. For example, one might dictate into a cell phone memory at 740 regarding an idea for a source code module that may be useful for other developers to know about. Data that is captured via the cell phone is collected at 730 is annotated with the source code application at 720 and subsequently stored at 710. The storage at 710 could be on the cell phone or wirelessly updated via the cell phone for example. When the links database 710 is referenced in the future per selection by the respective application or user, one or more annotations 720 that have been previously stored can be retrieved and used as a contextual cue to facilitate collaboration among developers or users of a document or application.

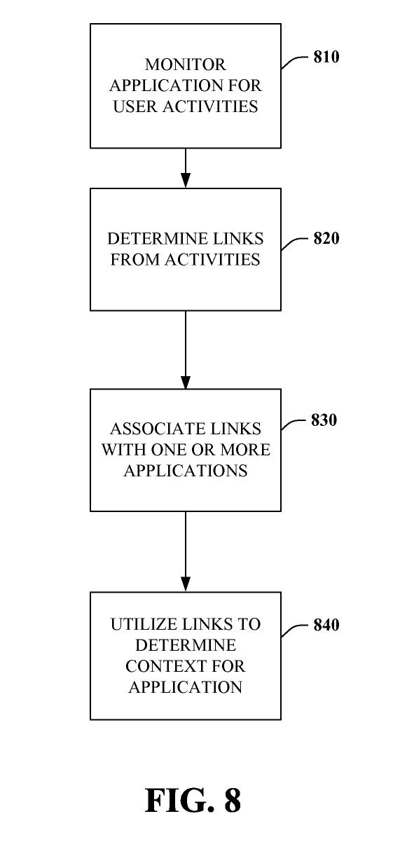

FIG. 8 illustrates an exemplary process 800 for automatically determining and embedding context links or cues in accordance with one or more applications. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Proceeding to 810 of the process 800, applications are monitored for user activity. Activities can include e-mails, meeting notes, audio files where an application is discussed, video data, presentation data, and substantially any type of data that is associated with a given application. In a developer application, this could include all the meetings and discussions relating to source code in addition to follow-up e-mails related to the code, for example. At 820, links or related tags are automatically determined for a given application, where the links or embedded cues are employed to determine relevant contexts for the application to facilitate further collaboration among users or systems. Proceeding to 830, the links are associated with an application. Links can be embedded as metadata or embedded under a user interface tab for example, to show users of the application that there is further contextual data (e.g., notes, conversations, e-mails, comments, and so forth) that was generated for the application.

At 840, the links that were associated at 830 can now be employed by one or more users of the respective application. For example, the links can be employed to determine who else is working on the application, who has worked on it in the past, the current wave of thinking for the application, what is happing at this moment or right now, who are likely collaborators, and so forth. As noted previously, such links can be inferred from profiles and from metadata queries of e-mails, documents, applications, and so forth. By determining other related entities, workers who work alone can collaborate with a larger and sometimes unknown group and leveraging ideas from the group via the associated links or cues.

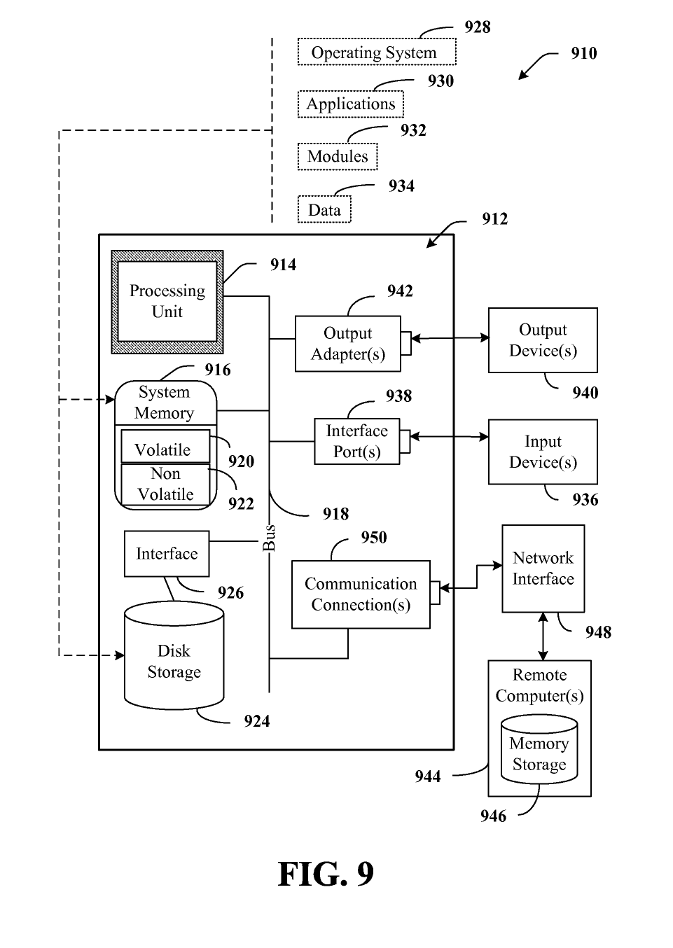

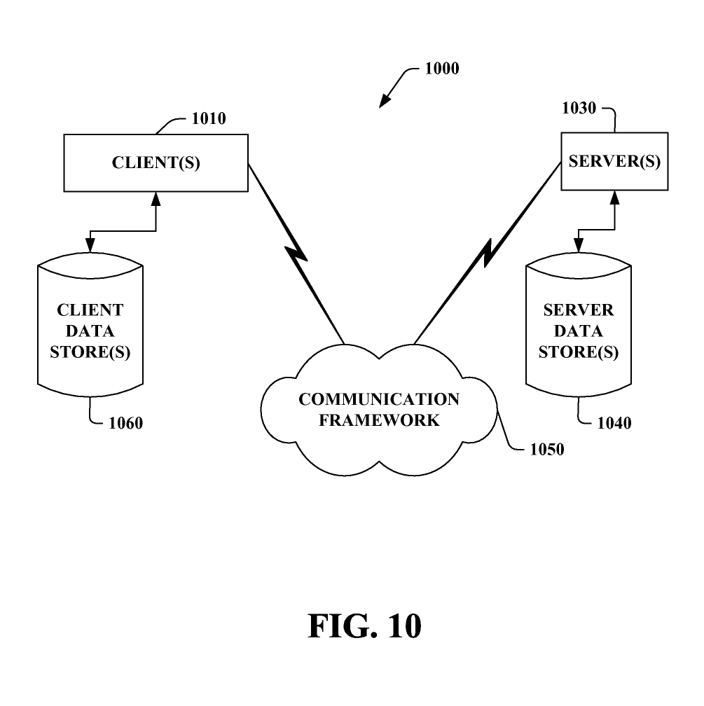

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couple system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to facilitate documentation processing, comprising:
one or more embedded components associated with an application; and
a linking component to automatically associate the embedded components with one or more related entities to the document; where the embedded components are employed to determine other relationships for the document.

2. The system of claim 1, further comprising a profile component to control data generated by the linking component.

3. The system of claim 2, the profile component includes a user type component, a link preferences component, a group preferences component, a media component, a time component, a calendar component, or a general settings component.

4. The system of claim 1, further comprising a filter component to control data generated by the linking component.

5. The system of claim 4, the filter component includes a language component, a selection component, a policy component, or a rules component.

6. The system of claim 1, the linking component further comprises a word clues component, a word snippets component, a key word component, a learning component, a profile component, a filter component, or a statistical component.

7. The system of claim 1, further comprising one or more controls to operate with the linking component.

8. The system of claim 7, the controls include a length component, a preferences component, a processing time component, a thumbnail component, and a learning component.

9. The system of claim 1, the linking component operates on mixed media data to generate one or more embedded cues.

10. The system of claim 9, the mixed media data is associated with text data, numeric data, audio data, image data, or video data.

11. The system of claim 9, the linking component generates data having at least two forms of mixed media.

12. The system of claim 1, further comprising an input component to capture data from a location.

13. The system of claim 12, further comprising a component to automatically modify the data from the location.

14. The system of claim 13, further comprising a component to store the data as an annotation from the location.

15. The system of claim 1, further comprising a learning component to determine one or more embedded components.

16. The system of claim 15, further comprising a monitor component that monitors user activities over time to determine context for a file.

17. The system of claim 1, further comprising an identifier component to determine input data for an embedded component.

18. A method to determine embedded cues, comprising:
automatically detecting a context from a meeting;
creating a data packet from the detected context; and
automatically associating the data packet with an application to provide the context to other systems or users.

19. The method of claim 18, further comprising employing a learning component to determine the context.

20. A data context system, comprising:
means for determining a context from a group;
means for receiving a data packet from the determined context; and
means for associating the data packet to provide the context to other systems or users.
